(19) United States
(12) Patent Application Publication
(10) Pub. No.: US 2026/0045734 A1
(43) Pub. Date: Feb. 12, 2026

(54) WIRE COVER FOR ELECTRICAL CONNECTOR

(71) Applicant: FCI USA LLC, Etters, PA (US)

(72) Inventor: Florian Bandinu, Besancon (FR)

(73) Assignee: FCI USA LLC, Etters, PA (US)

(21) Appl. No.: 19/359,584

(22) Filed: Oct. 15, 2025

Related U.S. Application Data
(63) Continuation of application No. PCT/IB2024/000377, filed on Jul. 10, 2024.
(60) Provisional application No. 63/603,046, filed on Nov. 27, 2023.

(51) Int. Cl. H01R 13/58; H01R 43/18

(52) U.S. Cl. CPC H01R 13/58; H01R 43/18

(57) ABSTRACT

A connector assembly configurable to support wires extending from a connector housing and routed away from the connector housing in any of multiple directions. The wire cover may have wire exit openings facing in multiple directions and may be attached to a connector housing in any of multiple orientations such that selection of an opening through which wires are routed and selecting an attachment orientation for the wire cover provides for four or more configurations.

### CROSS-REFERENCE TO RELATED APPLICATIONS

This application is continuation of International Application No. PCT/IB2024/000377, filed on Jul. 10, 2024, entitled “WIRE COVER FOR ELECTRICAL CONNECTOR,” which claims priority to and the benefit of U.S. Provisional Patent Application No. 63/603046, filed on Nov. 27, 2023, entitled “WIRE COVER FOR ELECTRICAL CONNECTOR.” The contents of these applications are incorporated herein by reference in their entirety.

### BACKGROUND

This disclosure relates generally to an electrical connector and, more specifically, to a wire cover for an electrical connector.

Many systems, such as vehicles or computers, may include separate electronic assemblies that are interconnected using electrical connectors. In some such systems, the electronic assemblies are joined using wires. One or more ends of the wires may be terminated to a connector that mates with a receptacle connector in one of the electronic assemblies to be connected with the wires.

In many applications, the electronic assemblies and the wiring that interconnects the various electronic assemblies may be routed in a particular direction relative to a housing of the connector. In a vehicle, for example, electronic assemblies may be distributed based on their function (e.g., electronic assemblies associated with window actuation at each of the windows) and the wires that connect the electronic assemblies (e.g., to a central controller) are kept out of the passenger cabin via routing through door panels and the like. Such constraints on routing paths for the wires can result in wires being directed to a connector at an indirect orientation (e.g., at a right angle) relative to the connector interface.

A wiring harness may be formed to make the desired connections within a larger electronic assembly, such as an automobile. A wiring harness may include multiple wires that are bundled, with each bundle terminated to a cable. Each of the bundles may have a length that enables the desired connections within the electronic assembly. To support and protect the wires, wire covers may be attached to housings of the connectors.

### SUMMARY

According to an aspect of the present disclosure, a connector assembly includes a housing comprising a first side. The housing receives a terminal terminated to a wire with the wire extending from the housing at the first side. A wire cover includes a first side and a first end transverse to the first side. The first side of the wire cover includes a first opening configured for the wire to pass therethrough. The first end of the wire cover includes a second opening configured for the wire to pass therethrough. The wire cover couples to the housing adjacent to the first side of the housing in any of a plurality of orientations including with the first side of the wire cover facing in a first direction, and with the first side of the wire cover facing in a second direction opposite to the first direction.

According to another aspect of the present disclosure, a wiring harness includes the connector assembly and a plurality of wires and corresponding terminals. Each of the plurality of wires extends from the housing of the connector assembly.

According to another aspect of the present disclosure, a connector assembly includes a housing and a cover including a plurality of walls, with wire exit openings through at least two of the plurality of walls. One of the covers and the housing has an attachment feature. The other of the cover and the housing has a first complimentary attachment feature and a second complimentary attachment feature, positioned such that the attachment feature is positioned to engage the first complimentary attachment feature when the cover is attached to the housing in a first orientation and is positioned to engage the second complimentary attachment feature when the cover is attached to the housing in a second orientation.

According to another aspect of the present disclosure, a method of assembling a connector includes a housing and a wire extending from the housing such that the wire is guided by a cover to extend from the housing in one of four possible orientations includes orienting the wire in one of a plurality of orientations relative to the housing and aligning a cover to support the wire in the routed orientation. The method also includes attaching the cover to the housing.

The foregoing features may be used, separately or together in any combination in any of the foregoing embodiments.

### BRIEF DESCRIPTION OF DRAWINGS

The accompanying drawings are not necessarily drawn to scale. For the purposes of clarity, not every component may be labeled in every drawing. In the drawings:

FIG. 1A is a perspective view of an exemplary plug assembly terminating a group of wires in a wiring harness, with a wire cover configured for routing wires in a first direction;

FIG. 1B is a perspective view of the plug assembly of FIG. 1A with the wire cover configured for routing wires in a second direction, which in this example is perpendicular to the first direction;

FIG. 1C is a perspective view of a plug assembly of FIG. 1A with the wire cover configured for routing wires in a third direction, which in this example is opposite the first direction;

FIG. 2 is an exploded view of the plug assembly of FIG. 1A;

FIG. 3 is an exploded view of the plug assembly of FIG. 1C, with wires omitted;

FIG. 4A is a perspective view of the wire cover of FIG. 1A showing exemplary engagement features;

FIG. 4B is a different perspective view of the wire cover shown in FIG. 4A;

FIG. 5A is a perspective view of the plug assembly in the configuration of FIG. 1C, with wires omitted showing attachment of the wire cover to the plug housing;

FIG. 5B is a sectional view of the plug assembly taken along line B-B in FIG. 5A, showing engagement of the guide posts of the wire cover in guide rails of the plug housing;

FIG. 6A is a perspective view of an exemplary board mount connector assembly with a wire cover configured for routing wires in a first direction;

FIG. 6B is a perspective view of the connector assembly of FIG. 6A with the wire cover configured for routing wires in a second direction, which in this example is perpendicular to the first direction;

FIG. 6C is a perspective view of the connector assembly of FIG. 6C with the wire cover configured for routing wires in a third direction, which in this example is opposite to the first direction;

FIG. 7A shows a perspective view of an exemplary plug assembly in a first arrangement;

FIG. 7B shows a perspective view of the exemplary plug assembly of FIG. 7A in a different arrangement;

FIG. 8A is an exploded view of the plug assembly that shows guiding posts of the wire cover;

FIG. 8B is an exploded view of the plug assembly that shows a guide inlet of the plug housing;

FIG. 9A is a perspective view of an exemplary plug assembly in a first arrangement; and

FIG. 9B is a perspective view of the plug assembly of FIG. 9A in a different arrangement.

### DETAILED DESCRIPTION

The inventors have recognized and appreciated connector assembly designs that enable robust and economical wiring harnesses. A connector assembly for terminating wires may be configurable for terminating one or more wires extending from the housing of the connector in any of multiple directions. Such a connector assembly may include a wire cover with multiple openings through which wires exiting the connector housing may be routed. Further, the cover may be attached to the housing in any of multiple orientations.

Such a connector assembly supports economical manufacture of wiring harnesses. For each termination of the wiring harness, for example, one of the openings in the wire cover may be selected for routing wires through the wire cover. Further, the orientation in which the wire cover is attached to the connector housing may be selected such that the selected opening faces in a desired direction relative to the connector housing. In this way, a single type of connector assembly may be used to protect and support wires extending from the connector housing in any of multiple directions.

In some examples, wires may extend through a rear face of a housing of the connector. Those wires may bend relative to the rear face approximately ninety degrees for routing away from the connector in a desired direction. The wire cover may be attached to the connector housing adjacent the rear face. A wire cover, configurable as described herein, may support wires routed away from the connector in any of multiple desired directions, including to the left, right, up or down.

In some examples, engagement features between the wire cover and the plug housing may be symmetric such that the wire cover may be rotated 180 degrees. Such engagement features may facilitate two different engagement arrangements between the wire cover and the plug housing. In some examples, wires may enter the wire cover from two different directions at each of the two engagement arrangements. Thus, at least four different wire directions may be accommodated.

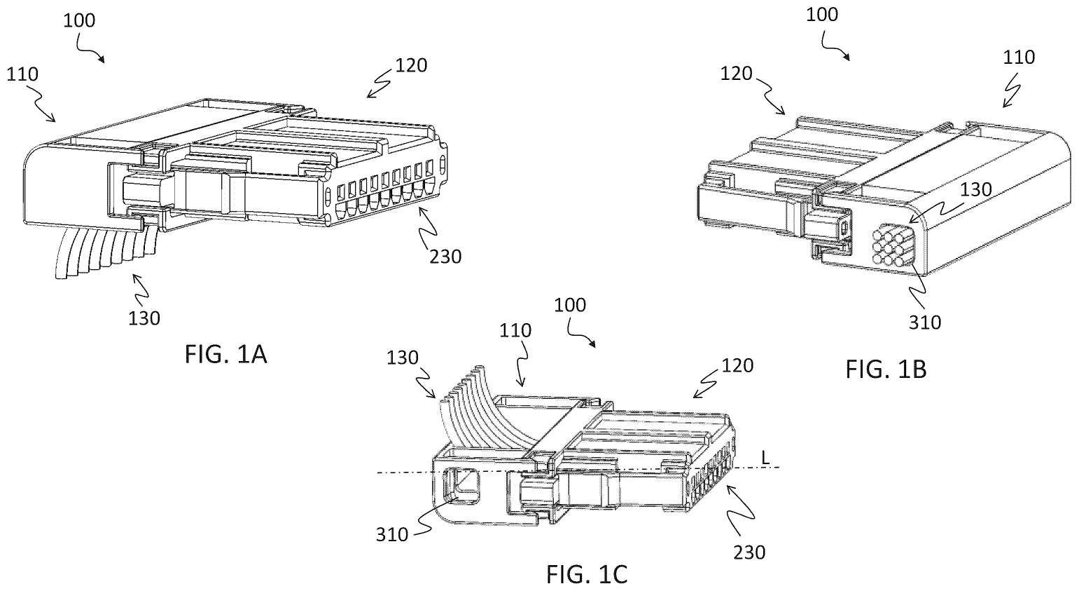

Turning to the figures, FIGS. 1A-9B illustrate aspects of a connector assembly with a configurable wire cover. In the examples provided, the wire cover may be mounted to a connector housing in any of multiple orientations. For explanatory purposes, a plug housing is illustrated with engagement features corresponding with engagement features of the wire cover. However, a wire cover with features as described herein may be used in engagement with a housing of other types of connectors, such as a receptacle, as well as of a plug.

FIGS. 1A, 1B, and 1C show different perspective views of an exemplary plug assembly 100 according to one or more embodiments. FIG. 1A is a perspective view of the plug assembly 100 according to an exemplary arrangement. Specifically, a wire cover 110 is engaged with a plug housing 120 according to a first orientation. As shown in the exemplary case, wires 130 exit the wire cover 110 to below. As discussed with reference to FIGS. 1B and 1C, wires 130 may alternately exit the wire cover 110 at a different angle, even for the same engagement arrangement between the wire cover 110 and plug housing 120. An exemplary feature of the plug housing 120 that is configured to engage with another connector is shown in FIG. 1A. Specifically, the plug housing 120 may include a mating face 230 that allows conductors of another connector to contact terminals (not shown) that are housed in the plug housing 120. Such terminals may be attached to the wires 130.

FIG. 1B is a perspective view of a plug assembly 100 according to the exemplary arrangement shown in FIG. 1A. That is, the orientation of the wire cover 110 relative to the plug housing 120 is the same in FIGS. 1A and 1B, but the view in FIG. 1B shows a different side of the plug assembly 100 from that shown in FIG. 1A. The view in FIG. 1B shows an exemplary feature of the wire cover 110 that is configured to route wires 130 through the wire cover 110 from the plug housing 120 differently than shown in FIG. 1A. Specifically, the wire cover 110 includes an opening 310 through which wires 130 may exit the wire cover 110 to be routed from the plug housing 120. As a comparison of FIGS. 1A and 1B shows, the same orientation of the wire cover 110 relative to the plug housing 120 facilitates wires 130 exiting the wire cover 110 from the bottom or from the right (according to the orientation shown in FIG. 1A).

FIG. 1C is a perspective view of a plug assembly 100 according to a second arrangement. In FIG. 1C, the plug housing 120 is shown in the same orientation as in FIG. 1A, but the wire cover 110 is rotated 180 degrees about a line L that goes through both the wire cover 110 and the plug housing 120. This change in orientation of the wire cover 110 relative to the plug housing 120 is facilitated by symmetry in the engagement features that connect the wire cover 110 to the plug housing 120, as further discussed herein. As shown in FIG. 1C, the wires 130 exit the wire cover 110 from above, based on the orientation of the wire cover 110. With the same orientation of the wire cover 110 shown in FIG. 1C, the wires 130 can also exit the wire cover 110 from the left, through the opening 310. Thus, the relative arrangement of the wire cover 110 and plug housing 120 shown in FIGS. 1A and 1B facilitate wires 130 exiting the wire cover 110 from below or from the right (according to the view in FIG. 1A) and the relative arrangement of the wire cover 110 and plug housing 120 shown in FIG. 1C facilitates wires 130 exiting the wire cover 110 from above or from the left (according to the view in FIG. 1C which shows a same orientation of the plug housing 120 as the view in FIG. 1A).

As can be seen from FIGS. 1A-1C, wire cover 110 may have multiple walls, some of which have openings through which wires extending from plug housing 120 may pass. In the example illustrated, wire cover 110 has walls defining ends and sides of a wire receiving space that wires 130 pass through. One or more of the ends and/or sides may have openings through which some or all of the wires 130 may pass. In the embodiment illustrated, one of the ends, referred to herein as an open end, may have one or more walls each with an opening therethrough. The walls at the opposite end, referred to herein as the closed end, are not configured for wires to pass therethrough. Similarly, one of the sides, referred to as an open side, may have one or more walls each with an opening therethrough. The walls at the opposite side, referred to herein as the closed side, are not configured for wires to pass therethrough.

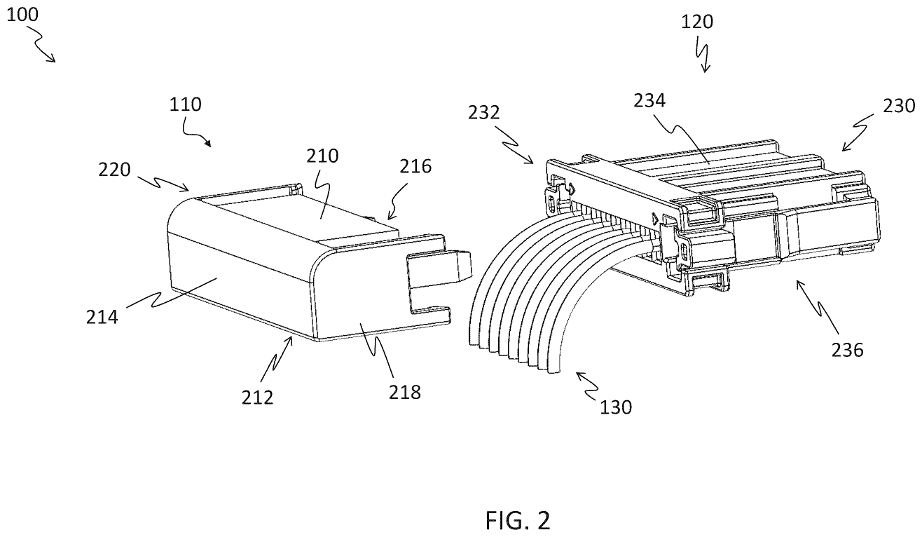

FIG. 2 is an exploded view of a plug assembly 100 in an exemplary arrangement. The orientation of the wire cover 110 relative to the plug housing 120 is similar to that in FIGS. 1A and 1C. In the example of FIG. 2, a covered side 210 of the wire cover 110 is visible while an open side 212 of the wire cover 110 (visible in FIG. 1C), which is opposite the covered side 210, is not visible in FIG. 2.

The wire cover 110 has a closed end 214 and an open end 216, opposite the closed end 214, which is the end of the wire cover 110 that couples to the plug housing 120. In this example, the covered side 210 and open side 212 are parallel to each other and are both perpendicular to the closed end and the open end. A closed edge 218 of the wire cover 110 is opposite an open edge 220, which includes the opening 310 shown in FIGS. 1B and 1C. The closed edge 218 and the open edge 220 are perpendicular to the covered side 210 and open side 212, as well as the closed end 214 and the open end 216. The exemplary illustrations and labels of the closed end 214, covered side 210, and closed edge 218 are used for explanatory purposes to differentiate, respectively, from the open end 216, open side 212, and open edge 220. However, the closed end 214, covered side 210, and closed edge 218 are not intended to be limited by their exemplary illustrations and may include one or more open areas rather than having continuous surfaces. Further relative to the plug assembly 100, the closed end 214 and open end 216 may be regarded as the distal end and the proximal end, respectively.

The plug housing 120 includes a first end, which includes the mating face 230 that is visible in FIGS. 1A and 1C, and a second end, which includes a terminal receiving face 232, opposite the mating face 230, where terminals of the wires 130 are received and housed in the plug housing 120. The plug housing 120 also includes a first side 234, shown as the top in FIG. 2, and a second side 236, opposite the first side 234. Additional aspects of the plug assembly 100 are discussed with reference to

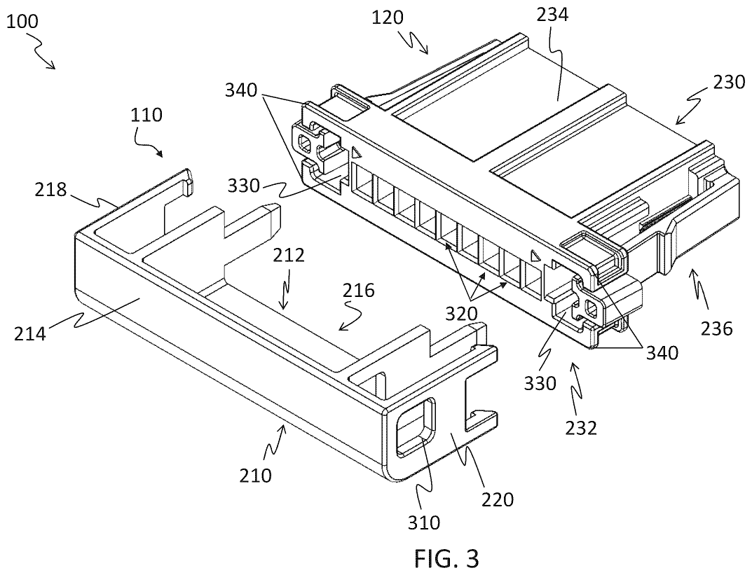

FIG. 3 is an exploded view of a plug assembly 100 in an exemplary arrangement that differs from the arrangement shown in FIG. 2. According to the arrangement in FIG. 2, the covered side 210 of the wire cover 110 is adjacent to the first side 234 of the plug housing 120. According to the arrangement in FIG. 3, the open side 212 of the wire cover 110 is adjacent to the first side 234 of the plug housing 120. That is, while the orientation of the plug housing 120 is the same in FIG. 2 as in FIG. 3, the orientation of the wire cover 110 is rotated 180 degrees about the terminal receiving face 232 of the plug housing 120 in FIG. 3 relative to FIG. 2. That is, the open side of the wire cover 110 is on top according to the view in FIG. 3.

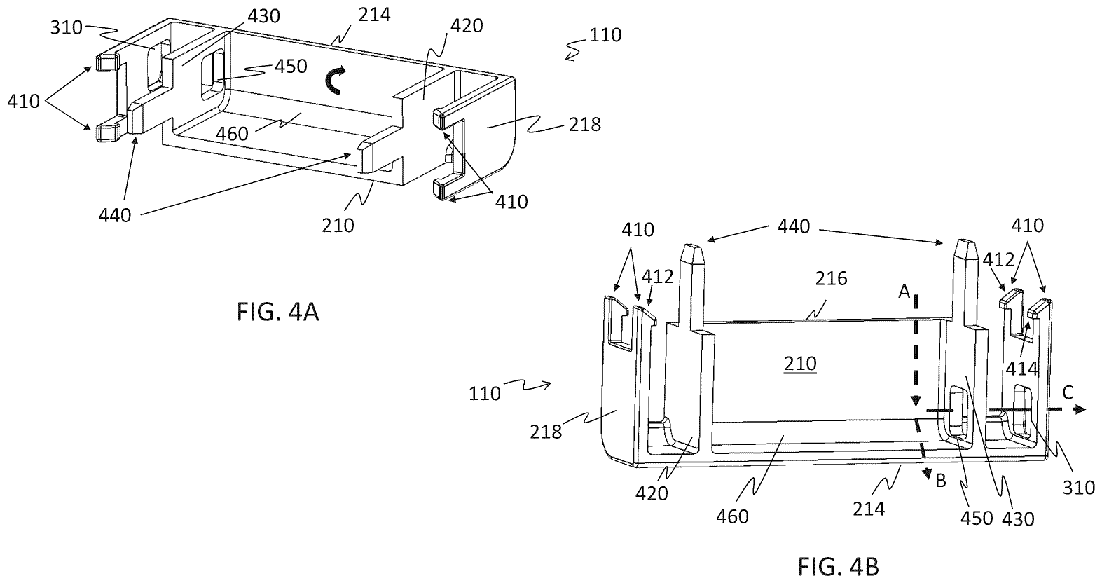

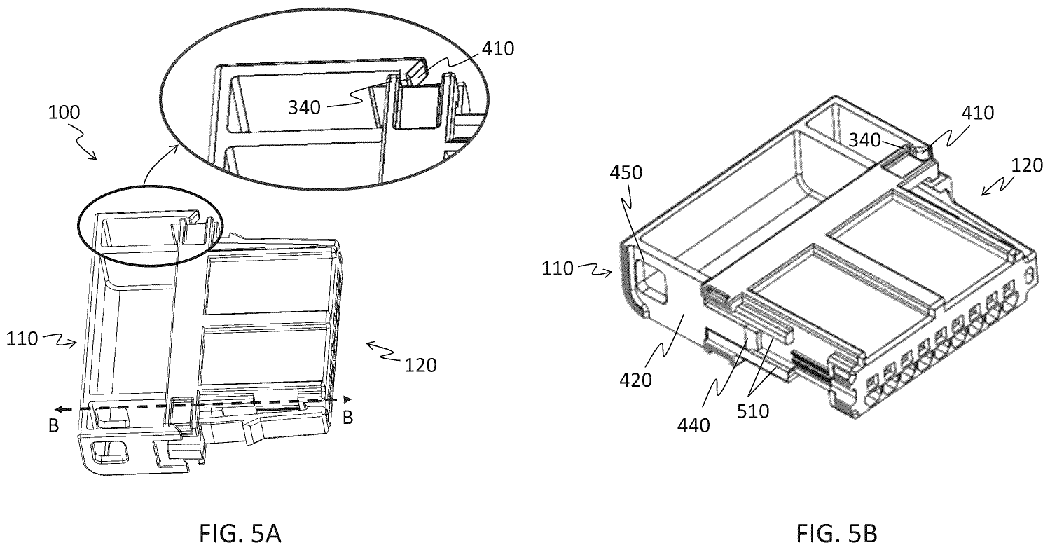

The orientation of the wire cover 110 in FIG. 3 makes the exemplary engagement features of the wire cover 110 visible. The engagement features facilitate engagement of the wire cover 110 with the plug housing 120. These engagement features are further discussed with reference to FIGS. 4A and 4B. The orientation in FIG. 3 also makes the opening 310 in the open edge 220 of the wire cover 110 visible. The wires 130 are not shown to more clearly show the wire passages 320 and guide inlets 330 in the terminal receiving face 232 of the plug housing 120. The wires 130 exit the plug housing through the wire passages 320 of the plug housing 120 at the terminal receiving face 121 and subsequently exit the wire cover 110 at a particular orientation, as shown in FIGS. 1A, 1B, and 1C. The plug housing 120 has a latch engagement edge 340 at each corner of the terminal receiving face 232. The guide inlets 330 and latch engagement edges 340 are further discussed with reference to FIGS. 5A and 5B.

FIGS. 4A and 4B show aspects of the wire cover 110. FIG. 4A is a perspective view of a wire cover 110 that shows symmetric engagement features used to attach the wire cover 110 to the plug housing 120. The exemplary engagement features include latches 410 on each of the closed edge 218 and the open edge 220 of the wire cover 110. Each of the latches 410 engages with a latch engagement edge 340 of the plug housing 120. Each latch 410 is an example of an attachment feature with a correspond edge 340 exemplifying a complementary attachment feature. The symmetry of the attachment features and complementary attachment features around the wire cover 110 and the plug housing 120 facilitate changing the orientation of the wires cover 110 relative to the plug housing 120.

An inner closed wall 420 and an inner open wall 430 are parallel to the closed edge 218 and open edge 220, as shown, with the inner closed wall 420 being closer to the closed edge 218 and the inner open wall 430 being closer to the open edge 220. As noted with regard to the label and illustration of closed edge 218, neither the label nor illustration of the exemplary inner closed wall 420 is intended to limit the inner closed wall 420 as having a continuous surface. The distance between the closed edge 218 and inner closed wall 420 may be substantially equal to the distance between the open edge 220 and the inner open wall 430, contributing to the symmetry discussed herein.

Both the inner closed wall 420 and the inner open wall 430 have a guiding post 440 extending from the edge that facilitates alignment with the plug housing 120. The guiding posts 440 enter the guide inlets 330 of the plug housing 120 and facilitate alignment between the wire cover 110 and the plug housing 120. The guiding posts 440 are symmetrical. That is, each guiding post 440 is the same on opposite sides (e.g., according to the view in FIG. 4A, the top and bottom of each guiding post 440 is the same and the left and right sides of each guiding post 440 is the same). As such, when the wire cover 110 is rotated 180 degrees according to the direction of rotation indicated by the arrow, from the perspective of a plug housing 120 that is unchanged based on the rotation of the wire cover 110, the guiding posts 440 will be identical before and after the rotation. This is the case even though the guiding posts 440 shown in FIG. 4A will exchange positions and also be upside down based on the rotation. The guiding posts 440, like the latches 410, may be regarded as engagement features to engage the wire cover 110 and the plug housing 120 and, in some embodiments, may include additional attachment features.

The latches 410, like the guiding posts 440, are symmetrical. As shown, there are two latches 410 at each edge. All the latches 410 are the same, meaning that each latch 410 is on the inside of the wire cover 110 rather than on the outside. In addition, each latch 410 is the same from above or below according to the view in FIG. 4A. Thus, based on their symmetric arrangement, rotating the wire cover 110 180 degrees according to the direction of rotation indicated by the arrow results in the latches 410 being in the same positions from a perspective of an unchanged plug housing 120. This is the case even though the two latches 410 on the closed edge 218 will exchange positions with the two latches 410 on the open edge 220 and the two bottom latches 410 and the two top latches 410 will change positions according to the view in FIG. 4A.

FIG. 4B is a perspective view of the wire cover 110 in FIG. 4A that shows additional views of the engagement features used to attach the wire cover 110 to the plug housing 120. The two latches 410 on the closed edge 218 and the two latches 410 on the open edge 220 are visible, as are the guiding posts 440 extending from the inner closed wall 420 and the inner open wall 430. As FIG. 4B shows, the guiding posts 440 extend farther than the latches 410 to facilitate alignment between the wire cover 110 and the plug housing 120 prior to engagement with the latches 410.

As the view makes clear, the latches 410 have an angled end 412 and a protrusion 414. The closed edge 218 and the open edge 220 may flex outward slightly to facilitate pushing the angled end 412 of the latches 410 past the latch engagement edges 340 of the plug housing 120. As each latch 410 is pushed past a corresponding latch engagement edge 340 of the plug housing 120, the width of the latch 410 increases based on the angled end 412. Once the latch 410 is pushed past the latch engagement edge 340, the protrusion 414 prevents the latch 410 from easily disengaging from the latch engagement edge 340. This is shown in FIG. 5A.

A transition 460 between the covered side 210 and the closed end 214 is visible in FIGS. 4A and 4B. In FIG. 4B, the covered side 210 is horizontal and the closed end 214 is vertical. The transition 460 is shown as a curved connection between the horizontal and vertical components. By smoothing the 90 degree angle between the covered side 210 and the closed end 214 with the transition 460, the wires 130 may be more easily guided through the wire cover 110 when exiting the plug housing 120. Specifically, the wires 130 may enter the wire cover 110 from the plug housing 120 at the open end 216, as indicated by the arrow A, and exit the wire cover 110 by transitioning between the covered side 210 to the closed end 214, as indicated by the arrow B, to the open side 212 or by going through the inner opening 450 and opening 310, as indicated by the arrow C.

FIG. 5A is a perspective view of the plug assembly 100 showing attachment of the wire cover 110 to the plug housing 120. An enlarged view is provided of one of the four attachment points around the terminal receiving face 232 of the plug housing 120. As shown, the latch 410 and, more specifically, the protrusion 414 of the clip prevents the clip from being easily retracted to pull the wire cover 110 away from the plug housing 120 once the two are engaged.

FIG. 5B is a sectional view of the plug assembly taken along line B-B in FIG. 5A. The view shows engagement of the guiding posts 440 of the wire cover 110 in guide rails 510 of the plug housing 120. When the wire cover 110 is being attached to the plug housing 120, insertion of the guiding posts 440 into the guide inlets 330 and between the guide rails 510 facilitates alignment between the wire cover 110 and the plug housing 120. This alignment facilitates pushing each of the latches 410 of the wire cover 110 past the corresponding latch engagement edge 340 of the plug housing 120 in order to attach the wire cover 110 to the plug housing 120.

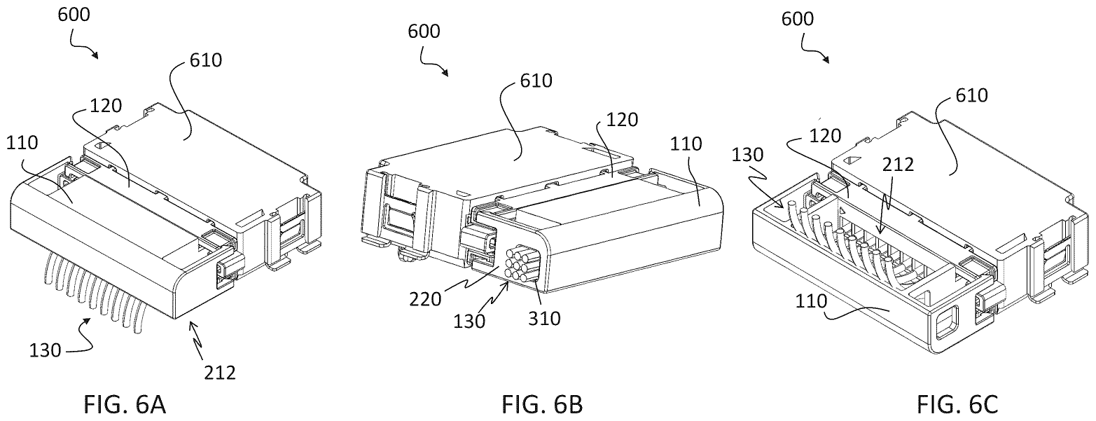

FIGS. 6A, 6B, and 6C show perspective views of a connector assembly 600 with different wire arrangements. A connector assembly 600 includes the wire cover 110 and plug housing 120 connected to another connector 610. Specifically, the mounting face 230 of the plug housing 120 may be coupled to the connector 610. The connector 610 may be mounted on a PCB, for example. FIG. 6A shows a perspective view of a connector assembly 600 with wires 130 exiting the open side 212 of the wire cover 110. FIG. 6B shows a perspective view of a connector assembly 600 with wires 130 exiting from the opening 310 in the open edge 220 of the wire cover 110. FIG. 6C shows a perspective view of a connector assembly 600 with wires 130 exiting from the open side 212 of the wire cover 110 in a different arrangement than the one shown in FIG. 6A. As shown, the wires 130 exit to the bottom in FIG. 6A while the wire cover 110 is rotated 180 degrees in FIG. 6C such that the wires 130 exit to the top.

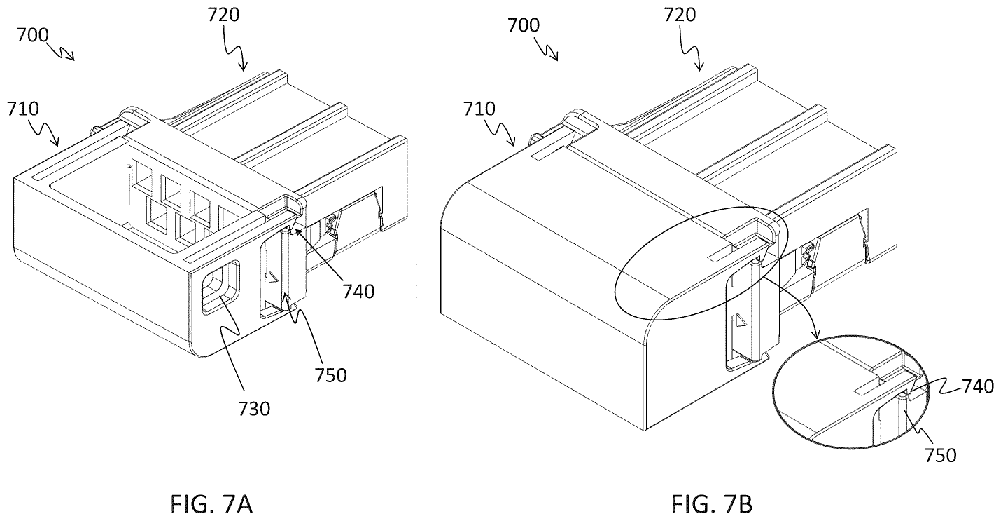

FIG. 7A shows a perspective view of an exemplary plug assembly 700 in a first arrangement. The plug assembly 700 shown in FIG. 7A is similar to the plug assembly 100 shown in FIG. 1C. The plug assembly 700 includes a wire cover 710 and a plug housing 720. In the exemplary arrangement shown in FIG. 7A, the opening 730, which is similar to the opening 310, is visible.

The latches 740 of the wire cover 710 are oriented differently than the latches 410 of the wire cover 110. Specifically, according to the view in FIG. 7A, the latches 740 are rotated 90 degrees relative to the latches 410 of the wire cover 110 shown in FIG. 5A, for example. The engagement of each latch 740 with a corresponding of a latch engagement edge 750 is similar to the engagement discussed for the plug assembly 100.

FIG. 7B shows a perspective view of the exemplary plug assembly 700 of FIG. 7A in a different arrangement. Specifically, the wire cover 710 is rotated 180 degrees relative to the arrangement shown in FIG. 7A. An enlarged view is shown of a latch 740 engaging with the latch engagement edge 750. The latch 740 and latch engagement edge 750 are exemplary representations of an attachment feature and a corresponding attachment feature.

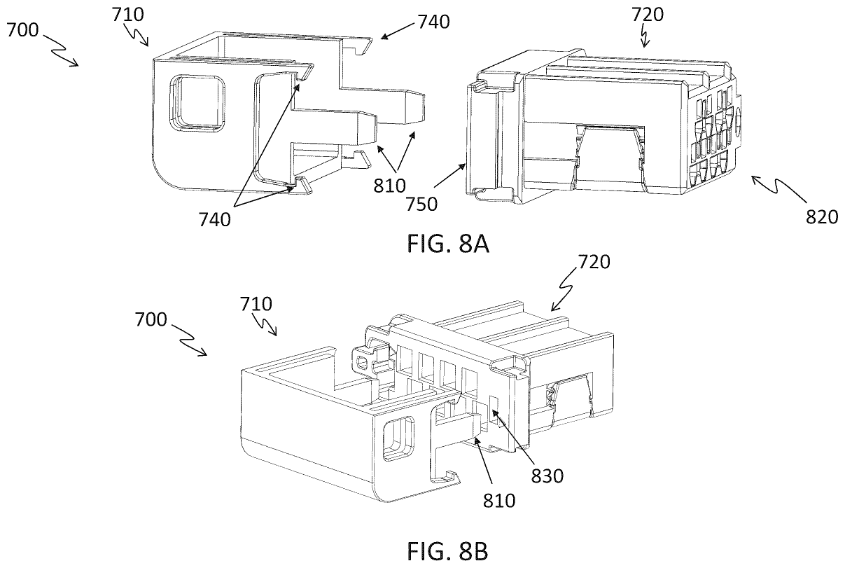

FIG. 8A is an exploded view of the plug assembly 700 that shows guiding posts 810 of the wire cover 710. As discussed with reference to FIG. 4A for the guiding posts 440 of the wire cover 110, the guiding posts 810 are symmetric in their shape and arrangement.

FIG. 8A also shows the mating face 820 of the plug housing 720 that facilitates a connection with another connector. As noted for the wire cover 110, the guiding posts 810 may represent additional or alternate attachment features.

FIG. 8B is an exploded view of the plug assembly 700 that shows a guide inlet 830 of the plug housing 720. As discussed for the plug assembly 100, the guiding posts 810 are inserted in corresponding guide inlets 830 to facilitate alignment between the wire cover 710 and the plug housing 720.

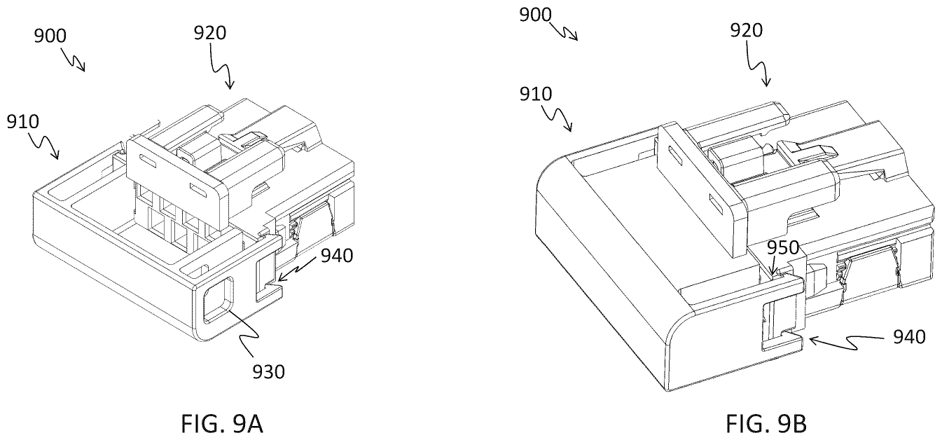

FIG. 9A is perspective view of an exemplary plug assembly 900 in a first arrangement. Like the plug assembly 100 and the plug assembly 700, the plug assembly 900 includes a wire cover 910 and a plug housing 920. The arrangement shown in FIG. 9A is similar to the arrangements in FIGS. 1C and 7A. In the exemplary arrangement shown in FIG. 9A, the opening 930, which is similar to the openings 310 and 730, is visible.

The latches 940 of the wire cover 910 are oriented similarly to the latches 410 of the wire cover 110 and differently than the latches 740 of the wire cover 710.

FIG. 9B is a perspective view of the plug assembly 900 of FIG. 9A in a different arrangement. Specifically, the wire cover 910 is rotated 180 degrees relative to the arrangement shown in FIG. 9A. The engagement of the latches 940 with corresponding latch engagement edges 950 is similar to the engagement discussed for the wire cover 110.

Having thus described at least one embodiment, it is to be appreciated various alterations, modifications, and improvements may readily occur to those skilled in the art. Such alterations, modifications, and improvements are intended to be within the spirit and scope of the invention.

For example, connector assemblies were illustrated with all wires extending from the connector housing routed in the same direction. As a wire cover may have multiple openings through which wires may be routed, some of the wires extending from the connector housing may pass through one of the openings and be routed away from the connector housing in one direction and others of the wires may extend through another opening and be routed away from the connector housing in a different direction.

As another example, a wire cover was illustrated as supporting wires exiting a connector housing through a face and bending at approximately 90 degrees relative to the face. Such wires may be routed away from the housing in a plane parallel to the face, and the cover is shaped to support wires in this orientation. In other examples, the wires may bend at other angles, such as 45 degrees, and the cover may be shaped to support wires bent at these angles.

Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

Terms signifying direction, such as “upwards” and “downwards” or front and back were used in connection with some embodiments. These terms were used to signify direction based on the orientation of components illustrated or connection to another component, such as a surface of a printed circuit board to which a termination assembly is mounted or the mating face of a connector. It should be understood that electronic components may be used in any suitable orientation. Accordingly, terms of direction should be understood to be relative, rather than fixed to a coordinate system perceived as unchanging, such as the earth's surface.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The indefinite articles “a” and “an,” as used herein in the specification and in the claims, unless clearly indicated to the contrary, should be understood to mean “at least one.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Also, the phraseology and terminology used herein are for the purpose of description and should not be regarded as limiting. The use of “including,” “comprising,” “having,” “containing,” or “involving,” and variations thereof herein, is meant to encompass the items listed thereafter (or equivalents thereof) and/or as additional items.

What is claimed is:

1. A connector assembly comprising:
a housing; and
a cover comprising a plurality of walls, with wire exit openings through at least two of the plurality of walls;
wherein:
one of the cover and the housing has an attachment feature; and
the other of the cover and the housing has a first complimentary attachment feature and a second complimentary attachment feature, positioned such that the attachment feature is positioned to engage the first complimentary attachment feature when the cover is attached to the housing in a first orientation and is positioned to engage the second complimentary attachment feature when the cover is attached to the housing in a second orientation.

2. The connector assembly according to claim 1, wherein the attachment feature of the cover is a latch and the first complimentary attachment feature and the second complimentary attachment feature of the housing are a first latch engagement edge and a second latch engagement edge.

3. The connector assembly according to claim 2, wherein the cover has a second latch positioned to engage the second latch engagement edge when the cover is attached to the housing in the first orientation in which the latch is positioned to engage the first latch engagement edge and to engage the first latch engagement edge when the cover is attached to the housing in the second orientation in which the latch is positioned to engage the second latch engagement edge.

4. The connector assembly according to claim 1, wherein the cover has the attachment feature is a guiding post that extends from the cover into the housing and the housing has the first complimentary attachment feature and the second complimentary attachment feature is a first pair of guide rails and a second pair of guide rails, wherein each of the first pair of guide rails and the second pair of guide rails has rails positioned to be adjacent to opposite sides of the guiding post.

5. The connector assembly according to claim 4, wherein the cover has a second guiding post positioned to engage the second pair of guide rails when the cover is attached to the housing in the first orientation in which the guiding post is positioned to engage the first pair of guide rails and to engage the first pair of guide rails when the cover is attached to the housing in the second orientation in which the guiding post is positioned to engage the second pair of guide rails.

6. The connector assembly according to claim 1, wherein the housing comprises a second side including a mating face configured to mate with another connector.

7. The connector assembly according to claim 6, wherein a first side of the housing includes an opening for the wire extending from the housing.

8. The connector assembly according to claim 1, wherein:
the wire cover includes a second end opposite a first end, a second side opposite the first side, a proximal end configured to be coupled to the first side of the housing, and a distal end configured to be farthest from the housing, and the first end and the second end are perpendicular to the first side, the second side, the proximal end, and the distal end.

9. The connector assembly according to claim 8, wherein the wire cover is oriented such that the wire extending from the housing enters the wire cover from the proximal end of the wire cover and exits the wire cover through the second opening in the first end.

10. The connector assembly according to claim 9, wherein the wire cover is oriented such that the wire extending from the housing enters the wire cover from the proximal end of the wire cover exits the wire cover through the first opening in the first side.

11. The connector assembly according to claim 8, wherein the wire cover includes a curved transition between the distal end and the second side.

12. A wiring harness comprising:
a connector assembly comprising:
a housing comprising a first side, wherein the housing is configured to receive a terminal terminated to a wire with the wire extending from the housing at the first side;
a wire cover comprising a first side and a first end transverse to the first side, wherein:
the first side of the wire cover comprises a first opening configured for the wire to pass therethrough;
the first end of the wire cover comprises a second opening configured for the wire to pass therethrough;
the wire cover is configured to couple to the housing adjacent to the first side of the housing in any of a plurality of orientations, the plurality of orientations comprising:
with the first side of the wire cover facing in a first direction;
and
with the first side of the wire cover facing in a second direction opposite to the first direction; and
a plurality of wires and corresponding terminals, wherein each of the plurality of wires extends from the housing of the connector assembly.

13. The wiring harness according to claim 12, wherein the wires of the wiring harness:
enter the wire cover through a proximal end, configured to be coupled to the first side of the housing, of the wire cover and
exit the wire cover through the second opening in the first end.

14. The wiring harness according to claim 13, wherein the wires of the wiring harness enter the wire cover through the proximal end of the wire cover and exit the wire cover through the first opening in the first side.

15. The wiring harness according to claim 14, wherein the wires of the wiring harness enter the wire cover through the proximal end of the wire cover and exit the wire cover through the first opening in the first side.

16. The wiring harness according to claim 12, further comprising a second connector assembly including a second housing and a second wire cover, wherein the plurality of wires of the wiring harness include a first set extending from the connector assembly and a second set extending from the second connector assembly.

17. The wiring harness according to claim 16, wherein the first set exits the wire cover and the second set exits the second wire cover through the first opening in the first side, through the second opening in the first end, through the first opening and through the second opening, respectively, or through the second opening and through the first opening, respectively.

18. The wiring harness according to claim 17, wherein the first side of the wire cover and the first side of the second wire cover face in the first direction, in the second direction, in the first direction and in the second direction, respectively, or in the second direction and in the first direction, respectively.

19. A method of assembling a connector comprising a housing and a wire extending from the housing such that the wire is guided by a cover to extend from the housing in one of four possible orientations, the method comprising:
orienting the wire in one of a plurality of orientations relative to the housing;
aligning a cover to support the wire in a routed orientation; and
attaching the cover to the housing.

20. The method according to claim 19, wherein aligning the cover is in a first orientation relative to the housing when the wire is oriented in a first one of the plurality of orientations relative to the housing and aligning the cover is in a second orientation relative to the housing, opposite the first orientation relative to the housing, when the wire is oriented in a second one of the plurality of orientations relative to the housing, opposite the first one of the plurality of orientations relative to the housing.

21. The method according to claim 20, wherein the aligning the cover is in the first orientation when the wire is oriented in a third one of the plurality of orientations relative to the housing and aligning the cover is in the second orientation relative to the housing when the wire is oriented in a fourth one of the plurality of orientations relative to the housing.

22. The method according to claim 21, wherein the third one of the plurality of orientations is opposite the fourth one of the plurality of orientations and the first one of the plurality of orientations and the second one of the plurality of orientations are perpendicular to the third one of the plurality of orientations and the fourth one of the plurality of orientations.

23. The method according to claim 22, further comprising guiding the wire through a wire exit opening when the wire is oriented in the third one of the plurality of orientations or in the fourth one of the plurality of orientations.
